(19) United States
(12) Patent Application Publication
(10) Pub. No.: US 2024/0419569 A1
(43) Pub. Date: Dec. 19, 2024

(54) STRUCTURE DETECTING APPARATUS AND STRUCTURE DETECTING KIT APPLYING THE SAME

(71) Applicant: INDUSTRIAL TECHNOLOGY RESEARCH INSTITUTE, Hsinchu (TW)

(72) Inventors: Hung-Chih CHANG, Hsinchu City (TW); Yao-Long TSAI, Kaohsiung City (TW); Li-Hua WANG, Hsinchu City (TW)

(73) Assignee: INDUSTRIAL TECHNOLOGY RESEARCH INSTITUTE, Hsinchu (TW)

(21) Appl. No.: 18/399,266

(22) Filed: Dec. 28, 2023

Related U.S. Application Data
(63) Continuation-in-part of application No. 17/405,423, filed on Aug. 18, 2021.
(60) Provisional application No. 63/071,382, filed on Aug. 28, 2020.

(30) Foreign Application Priority Data
Jun. 8, 2021 (TW) 110120800

(51) Int. Cl. G06F 11/27; G01N 29/12; G01N 29/265; G01N 29/46

(52) U.S. Cl. CPC G06F 11/27; G01N 29/12; G01N 29/265; G01N 29/46; G01N 2291/014; G01N 2291/2634

(57) ABSTRACT

A structure detecting apparatus used for receiving at least one under-test acoustic signal of an under-test structure and determining a structural state of the at least one under-test structure includes a communication interface, a filter amplifier circuit and a logic circuit. The communication interface is used to receive the at least one under-test acoustic signal. The filter amplifier circuit is used to filter the at least one under-test acoustic signal and output at least one filtered-and-amplified signal. The logic circuit includes a diagnostic model configured with a convolutional neural network (CNN) and is used to determine the structural state of the at least one under-test structure based on the at least one filtered-and-amplified signal.

This application is a continuation-in-part application (CIP) of U.S. application Ser. No. 17/405,423, filed Aug. 18, 2021, which claims the benefit of U.S. provisional application Ser. No. 63/071,382, filed Aug. 28, 2020, and Taiwan Application No. 110120800, filed Jun. 8, 2021, the subject matters of which are incorporated herein by reference.

### TECHNICAL FIELD

The disclosure relates in general to a structure detecting apparatus and structure detecting kit applying the same, and more particularly to an apparatus using acoustic resonance diagnostic technology to detect the condition of an under-test structure and kit applying the same.

### BACKGROUND

Over the years, there have been several accidents related to industrial structures or pipelines. When the industrial structures or pipelines degenerate or leak due to abnormality, severe disasters will occur and end up with casualties and property loss. The abnormality of industrial structures or pipelines are caused mainly by human factors and secondly by the degeneration of the material of industrial structures, pipes or equipment. To avoid the occurrence of disasters, it is essential to monitor the degeneration or leakage of industrial structures or pipelines.

Although the industries have developed several systems and technologies for monitoring industrial structures or pipelines, there still exist many accompanying problems to be resolved. For example, the safety diagnostic module lacks suitable logic judgement, and therefore needs to be evaluated by professionals; the current technology can only suitable for inspection and monitoring of the local degeneration at which the sensor is located and cannot sense the degeneration at a remote end; the current technology cannot emit a warning signal before degeneration occurs; the current technology relies on the inspectors walking to the site to listen to the acoustic change of the pipe.

Therefore, it has become a prominent task for the industries to provide an advanced structure detecting apparatus and structure detecting kit applying the same.

### SUMMARY

According to one embodiment, a structure detecting apparatus is provided and used for receiving at least one under-test acoustic signal of an under-test structure and determining a structural state of the at least one under-test structure. The structure detecting apparatus includes a communication interface, a filter amplifier circuit and a logic circuit. The communication interface is used to receive the at least one under-test acoustic signal. The filter amplifier circuit is used to filter the at least one under-test acoustic signal and output at least one filtered-and-amplified signal. The logic circuit includes a diagnostic model configured with a convolutional neural network (CNN) and is used to determine the structural state of the at least one under-test structure based on the at least one filtered-and-amplified signal.

According to another embodiment, a structure detecting kit is provided and used for receiving at least one under-test acoustic signal of at least one under-test structure and determining a structural state of the under-test structure. The structure detecting kit includes an acoustic sensing apparatus and a structure detecting apparatus. The structure detecting apparatus includes a communication interface, a filter amplifier circuit and a logic circuit. The acoustic sensing apparatus is used to collect and output the at least one under-test acoustic signal from the at least one under-test structure. The communication interface is electrically connected to the acoustic sensing apparatus and receives the at least one under-test acoustic signal. The filter amplifier circuit is used to filter the at least one under-test acoustic signal and output at least one filtered-and-amplified signal. The logic circuit includes a diagnostic model includes a CNN and is used to determine the structural state of the at least one under-test structure based on the at least one filtered-and-amplified signal.

As disclosed in above embodiments, the present disclosure provides a structure detecting apparatus and structure detecting kit applying the same using acoustic resonance diagnostic technology to determine the structural state of at least one under-test structure. Wherein, at least one communication interface, a filter amplifier circuit and a logic circuit are integrated into the structure detecting apparatus. The communication interface is used, in a contact or non-contact manner, to receive at least one under-test acoustic signal that is collected from the at least one under-test structure and outputted by a remote acoustic sensing unit or a proximal acoustic sensing unit. The received under-test acoustic signal is then filtered by the filter amplifier circuit and at least one filtered-and-amplified signal is outputted from the filter amplifier circuit. The state of the under-test structure can be determined by a diagnostic model configured with a CNN in the logic circuit based on the filtered-and-amplified signal output by the filter amplifier circuit. Thereby, remote sensing diagnosis and monitoring of the state of the under-test structure (for example, thinning and leakage of pipelines) can be realized to ensure the safe operation of the under-test structure (pipelines).

### BRIEF DESCRIPTION OF THE DRAWINGS

The above and other aspects of the invention will become better understood with regard to the following detailed description of the preferred but non-limiting embodiment(s). The following description is made with reference to the accompanying drawings.

FIG. 1 is a block diagram illustrating a structure detecting kit according to one embodiment of the present disclosure;

FIG. 2 is a spectrogram obtained by using a signal filtering unit to filter at least one under-test acoustic signal collected by an acoustic sensing unit from at least one under-test structure according to one embodiment of the present disclosure;

FIG. 3 is a flowchart of using the structure detecting kit as depicted in FIG. 1 to detect the structural state of the under-test structure according to one embodiment of the present disclosure;

FIG. 4 is a block diagram of a deep autoencoder according to one embodiment of the present disclosure;

FIG. 5 is a diagram illustrating a frequency band of an under-test acoustic signal in a leakage state according to one embodiment of the present disclosure;

FIG. 6 is a graph illustrating several amplitude vs position (length) curves of under-test sections with identical structural degradation feature (leakage) in different feature positions, that are stored in a database, according to one embodiment of the present disclosure;

FIG. 7 is a graph illustrating several amplitude vs position (length) curves corresponding to specific characteristic frequencies stored in the database according to one embodiment of the present disclosure;

FIG. 8 is a block diagram illustrating another structure detecting kit according to another embodiment of the present disclosure;

### DETAILED DESCRIPTION

The present disclosure provides a structure detecting apparatus and structure detecting kit applying the same using acoustic resonance diagnostic technology determining a structural state of an under-test structure to ensure safe operation of the under-test structure (pipelines). For the object, technical features and advantages of the present disclosure to be more easily understood by anyone ordinary skilled in the technology field, a number of exemplary embodiments are disclosed below with detailed descriptions and accompanying drawings.

It should be noted that these embodiments are for exemplary and explanatory purposes only, not for limiting the scope of the invention. The invention can be implemented by using other features, elements, methods and parameters. The preferred embodiments are merely for illustrating the technical features, not for limiting the protection scope thereof. Anyone skilled in the technology field of the invention will be able to make suitable modifications or changes based on the specification disclosed below without breaching the spirit of the invention. The identical elements of the embodiments are designated with the same reference numerals.

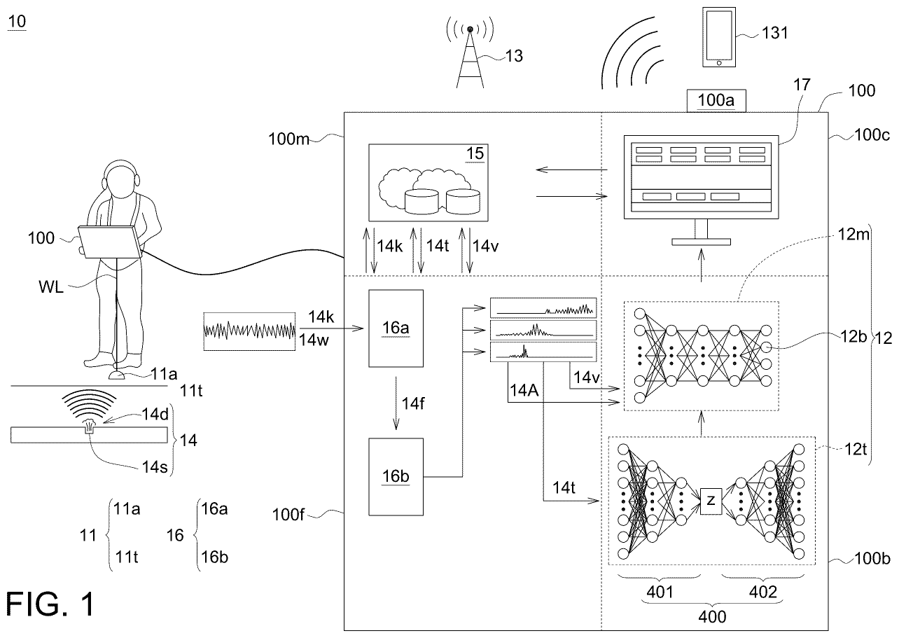

FIG. 1 is a block diagram illustrating a structure detecting kit 10 according to one embodiment of the present disclosure. The structure detecting kit 10 includes an acoustic sensing apparatus 11 and a structure detecting apparatus 100. The structure detecting apparatus 100 includes a communication interface 100a, a filter amplifier circuit 100f, a memory unit 100m and a logic circuit 100b.

The acoustic sensing apparatus 11 is used to collect at least one under-test acoustic signal 14k from an under-test section 14s of an under-test structure 14. In some embodiments of the present disclosure, the under-test structure 14 can be realized by (but not limited to) a pipeline structure, such as oil pipe, water pipe or other pipeline structure for transporting liquid or gas. The under-test structure 14 can be a solid structure, such as floor structure, road filling structure, steel-bone structure, or other structure capable of generating an acoustic signal through acoustic resonance. In one embodiment, the acoustic sensing apparatus 11 can collect at least one under-test acoustic signal 14k from the under-test section 14s of the under-test structure 14, in a non-contact manner or from a distance. In one embodiment, the acoustic sensing apparatus 11 can collect at least one under-test acoustic signal 14k from the under-test section 14s of the under-test structure 14, in a directly contact manner or in an indirectly contact manner.

In one embodiment of the present disclosure, the acoustic sensing apparatus 11 includes a proximal acoustic sensing unit 11a and an audio input/output interface 11t. The proximal acoustic sensing unit 11a can be (but not limited to) a portable high-sensitivity piezoelectric sensor which can be carried by the leakage inspectors to different positions of the under-test structure 14 (pipeline structure) to collect the under-test acoustic signal 14k from the under-test structure 14 (pipeline structure). The audio input/output interface 11t of the acoustic sensing apparatus 11 can be used to input and output of the under-test acoustic signal 14k. For example, in the present embodiment, the proximal acoustic sensing unit 11a of the acoustic sensing apparatus 11 may not be directly contact to the under-test structure 14 (pipeline structure), but separate from the under-test structure 14 (pipeline structure) for a certain distance; and the under-test acoustic signal 14k can be (but is not limited to) a time waveform.

The memory unit 100m of the structure detecting apparatus 100 may be (but not limited to) a memory chip. For example, in the present embodiment, the memory unit 100m includes a memory array composed of a plurality of non-volatile memory cells and a peripheral circuit (not shown) including a decoder, a data buffer and a sense amplifier, and can be used to construct a database 15 for storing the under-test acoustic signal 14k and various data for performing subsequent steps.

The communication interface 100a of the structure detecting apparatus 100 is electrically connected to the audio input/output interface 11t of the acoustic sensing apparatus 11, and receives the under-test acoustic signal 14k collected by the acoustic sensing apparatus 11. In the present embodiment, the communication interface 100a includes a signal line WL, which connects a handheld leak detection probe of the proximal acoustic sensing unit 11a and the filter amplifier circuit 100f of the structure detecting apparatus 100. The audio input/output interface 11t of the acoustic sensing apparatus 11 may include a bus and an input/output circuit connected to the signal line WL.

The filter amplifier circuit 100f of the structure detecting apparatus 100 may be a single-chip audio control circuit 16 for performing a filtering step, including performing a square wave Fast Fourier Transform (FFT) on the under-test acoustic signal 14k and performing a Mel-Frequency Cepstrum (MFC) analysis, and the output of which can be provided to the logic circuit 100b for performing the subsequent structural detection (hereinafter referred to as acoustic resonance diagnostic). The single-chip audio control circuit 16 includes an audio transcoder 16a and a filter amplifier 16b. Wherein, the audio transcoder 16a is used to perform conversion steps, and the filter amplifier 16b is used to perform spectrum analysis steps; and by which a filtered-and-amplified signal 14A can be obtained from each under-test acoustic signal 14k collected from the under-test structure 14 (pipeline structure).

In detail, the conversion steps performed by the audio transcoder 16a include performing a time domain to frequency domain conversion to convert the time waveform of each under-test acoustic signal 14k into a frequency-domain waveform; capturing a part of the frequency band of the frequency-domain waveform serving as a filtered signal 14f. The spectrum analysis steps performed by the filter amplifier 16b include capturing and amplifying the filtered signal 14f, and outputting a frequency domain band as the filtered-and-amplified signal 14A for subsequent acoustic resonance diagnosis.

In some embodiments of the present disclosure, the frequency band used for preforming the acoustic resonance diagnosis is substantially between 10 Hz˜1,800 Hz and preferably between 30 Hz˜1,600 Hz. The audio transcoder 16a performs a time domain to frequency domain conversion to convert the under-test acoustic signal 14k originally having a time-domain waveform into a frequency-domain waveform; a portion of the frequency-domain waveform is then captured and amplified to make the filtered under-test acoustic signal 14k passing through the filter amplifier 16b has a frequency domain band with a frequency.

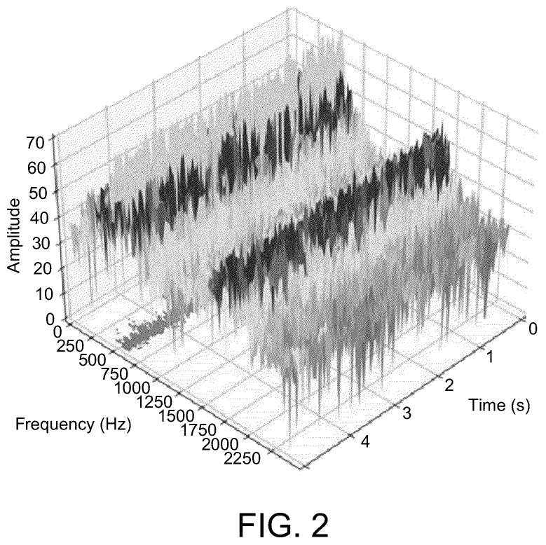

In one embodiment of the present, the filtering step includes using the audio transcoder 16a to perform a square wave FFT and a MFC analysis on the under-test acoustic signal 14k collected by the acoustic sensing apparatus 11. For example, the number of filters (e.g., the single-chip audio control circuits 16) is 30, the Mel frequency cepstrum coefficient (MFCC) is 20 dimensions, the frequency band is between 0 Hz˜44,100 Hz, the Fourier transform has 2,048 points, the size of the audio frame used in the audio file is 5 seconds(s). To avoid dramatic change between the audio frames, every two audio frames overlap by 20 milliseconds (ms). The three axes of the spectrogram 200 as depicted in FIG. 2 respectively are amplitude, frequency and time.

FIG. 2 is obtained as follows. the filtered signal 14f treated by the audio transcoder 16a can further be divided into 5 frequency bands according to the time axis (second) by the filter amplifier 16b, and each frequency band is further equally divided into 2,000 segments, and the frequencies and amplitudes of each segment are converted into two-dimensional vectors (serving as the filtered-and-amplified signal 14A) to form a 5 (time)×2,000(frequency and amplitude) matrix (a collection of three-dimensional vectors). The above step can be repeatedly performed on the signal data obtained through on-site inspection to covert each under-test acoustic signal 14k (including the signal that represents the waveforms of vibrating sound, hereinafter referred to as sound wave signal 14w) into an item of matrix data. At the end, about 430,000 items of 5×2,000 matrix data can be obtained. Then, the 430,000 items of 5×2,000 matrix data are stored in the database 15 according to the time sequence and are used as training data (serving as the training acoustic signal 14t and the verification sound wave signal 14v) for carrying a training to establish an acoustic resonance diagnostic module 12.

The structure detecting apparatus 100 of the logic circuit 100b includes the acoustic resonance diagnostic module 12, which can determine a structural state of the under-test structure 14 based on the filtered-and-amplified signal 14A (obtained by filtering the under-test acoustic signal 14k) and the sound wave signal 14w (currently stored in the database 15) as training data. (For example, the training acoustic signal 14t and the verification acoustic signal 14v). In some embodiments of the present disclosure, the logic circuit 100b may include an Artificial Intelligence (AI) chip, a Graphics Processing Unit (GPU), a Microcontroller Unit (MCU), etc. provided for establishing the acoustic resonance diagnostic module 12; and then the structural state of the under-test section can be determined by the acoustic resonance diagnostic module 12 based on the filtered under-test acoustic signal 14k (frequency domain band).

During the establishing of the acoustic resonance diagnostic module 12, each sound wave signal 14w must firstly be normalized before the data of the sound wave signal 14w can be trained using a deep learning algorithm. In the present embodiment, the normalization method can be such as min-max normalization. At a particular time point n, the readings obtained through 13 times of sampling form a 13×1 vector (or one-dimensional array) x[n]∈ R^{13×1}. The maximum and minimum of each reading respectively form 13×1 vectors xₘᵢₙ[n]∈ R^{13×1} and xₘₐₓ[n]∈ R^{13×1}. The vector x[n] is normalized according to formula (1):

$${x}_{norm} [ n ] = \frac{x [ n ] - {x}_{min} [ n ]}{{x}_{max} [ n ] - {x}_{min} [ n ]} . \qquad ( 1 )$$

The normalized reading xₙₒᵣₘ[n−1] obtained at the previous time point is subtracted from the reading xₙₒᵣₘ[n] obtained at the current time point, using difference methods (DM), which can be expressed as formula (2):

$${x}_{diff} [ n ] = \vert {x}_{norm} [ n ] - {x}_{norm} [ n - 1 ] \vert ∈ {R}^{13 \times 1} , \qquad ( 2 )$$

wherein, x_{diff} is a difference signal.

Next, the sum of the difference signal x_{diff} is calculated, and a threshold value is set, which can be expressed as formula (3):

$${\sum }_{n = 2}^{16} {{{x}_{diff} [ n ]}^{T} [ 11 … 1 ]}^{T} > threshold \qquad ( 3 )$$

If the sum of the difference signal is greater than the threshold value, it can be determined that the inputted sound wave signal 14w is a transient signal whose waveform changes dramatically; otherwise, it can be determined that the inputted sound wave signal 14w is a steady signal whose waveform is stable and gentle. The normalized sound wave signal 14w includes a normalized training acoustic signal 14t and a verification sound wave signal 14v, which can represent a transient signal and a steady signal respectively.

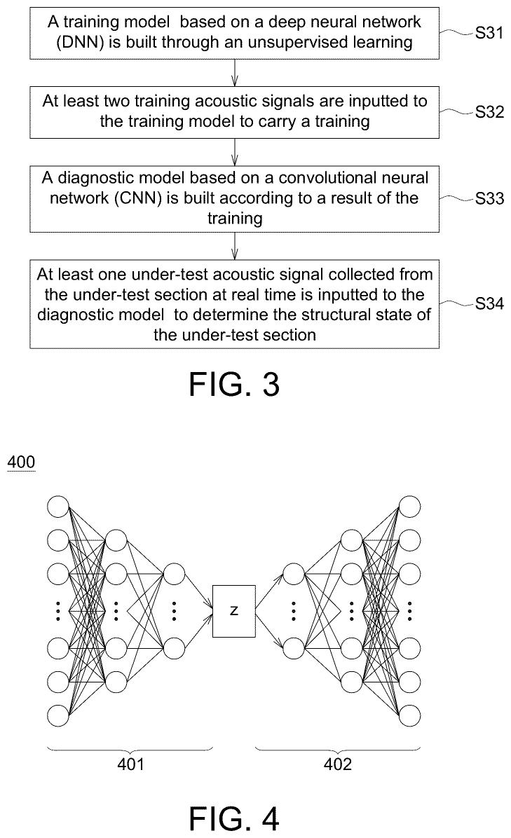

The acoustic resonance diagnostic module 12 is used to perform an acoustic resonance diagnostic method for detecting the structural state of the under-test structure 14. FIG. 3 is a flowchart of using the structure detecting kit 10 as depicted in FIG. 1 to detect the structural state of the under-test structure 14 according to one embodiment of the present disclosure. The acoustic resonance diagnostic method includes steps as follows: Firstly, a training model 12t based on a deep neural network (DNN) is built through an unsupervised learning (step S31). Then, at least two training acoustic signals 14t (stored in the database 15) are inputted to the training model 12t to carry a training (step S32) (the normalized sound wave signal 14w includes a normalized training acoustic signal 14t and a verification sound wave signal 14v). Then, a diagnostic model 12m based on a convolutional neural network (CNN) is built according to a result of the training (step S33). Then, at least one under-test acoustic signal 14k collected from the under-test section 14s at real time (currently) is inputted to the diagnostic model 12m to determine the structural state of the under-test section 14s (step S34).

In further details, the training model 12t of the acoustic resonance diagnostic module 12 may include a deep autoencoder 400 based on a deep convolutional network. FIG. 4 is a block diagram illustrating the deep autoencoder 400 according to one embodiment of the present disclosure. The deep autoencoder 400 can include an encoder 401 and a decoder 402, which are respectively used to compress and decompress the training acoustic signal 14t. In the present embodiment, the deep autoencoder 400 is built based on multiple full-connection layers, the encoder 401 has the maximum number of Input neurons on the inputting layer, and the number of neurons on the hidden layers of the encoder 401 diminishes layer by layer. Features of the original training acoustic signal 14t can be extracted through linear transformation or highly nonlinear transformation or the dimensionality reduction of the data.

The decoder 402 decompresses the output code of the encoder 401 to restore the inputted data. In other words, the input data and the output data of the deep autoencoder 400 would be the same. In the present embodiment, since the full-connection layers only accept the input of one-dimensional array, thus the sound wave signal 14w with a 5×2,000 input matrix, prior to being inputted to the deep autoencoder 400, should be flattened as 10,000 one-dimensional arrays. For example, the number of neurons on each layer of the encoder 401 diminishes from 10,000 to 5,000 and 2,500. The encoder 401 has three continuous full-connection layers. The decoder 402 has three continuous full-connection layers, respectively having 2,500, 5,000 and 10,000 neurons. At last, 10,000 values are outputted.

The training of the acoustic resonance diagnostic module 12 includes the following steps: Firstly, 80% of the sound wave signal 14w stored in the database 15 (for example, the data of the sound wave signal 14w that are classified as steady data and obtained according to formulas (2) and (3)) are selected and inputted into the deep autoencoder 400 of the training model 12t for extracting feature values through the encoder 401, whereby a plurality of representative features Z can be extracted from the original training acoustic signal 14t and several feature labels 12b are pre-selected. Through adjustment, it can be verified that the steady data having been treated with a compression process and a decompression process of the deep autoencoder 400 still possess excellent restoration performances. In the present embodiment, through the feature-extraction performed by the deep autoencoder 400, the training acoustic signal 14t basically can be classified into four feature labels 12b, namely, leakage frequency, metal frequency, ambient frequency (environmental frequency) and noise frequency.

Afterwards, the diagnostic model 12m including a convolutional autoencoder is built according to the feature labels 12b of the training model 12t using a convolutional neural network. The remaining 20% of the sound wave signal 14w (for example, the remaining data of the sound wave signal 14w that are classified as transient data and obtained according to formulas (2) and (3)) are inputted to the convolutional autoencoder of the diagnostic model 12m and used as verification data (also called as the verification sound wave signal 14v) to test whether the diagnostic model 12m can successfully detect the transient state. The criterion for determining the transient state is whether the error between the signal restored by the convolutional autoencoder of the diagnostic model 12m and the original signal is over a predetermined threshold value (the signal to noise ratio: 500). If so, the inputted training data are determined as transient data. In the present embodiment, the algorithms used by the convolutional autoencoder include the k-means clustering algorithm.

The output result of the diagnostic model 12m is compared with the verification data, and the weights and the number of feature labels 12b of the diagnostic model 12m are adjusted to complete the training of the acoustic resonance diagnostic module 12. After the training is completed, the sum of the feature values of the feature labels 12b of the diagnostic model 12m is equivalent to 1. In the present embodiment, the 4 feature labels respectively are: leakage frequency, metal frequency, ambient frequency and noise frequency.

After the training of the acoustic resonance diagnostic module 12 is completed, at least one under-test acoustic signal 14k that is collected from the under-test section 14s at real time (currently) is inputted to the diagnostic model 12m of the acoustic resonance diagnostic module 12, and the pipeline structure and the current structural state of the under-test section 14s of the under-test structure 14 (pipeline structure) from which the under-test acoustic signal 14k is collected can be determined according to the feature value outputted by each of the feature labels 12b of the diagnostic model 12m.

In some embodiments of the present disclosure, when the diagnostic model 12m determines that the under-test section 14s of the under-test structure 14 (pipeline structures) from which the under-test acoustic signal 14k is collected leaks, the acoustic resonance diagnostic module 12 can further compare the frequency band of the under-test acoustic signal 14k with the historical data of several sound wave signals with identical pipeline structures but different leakage features in terms of acoustic frequency offset and amplitude variation, wherein the historical data are stored in the database 15. Thus, relative position of the structural degradation feature 14d in the under-test section 14s of the under-test structure 14 (pipeline structure) can be recognized, and the degeneration of the structural degradation feature 14d can be estimated.

In some embodiments of the present disclosure, when the under-test section 14s is determined to be in a leakage state, the historical data of several sound wave signals with identical pipeline structure but different structural degradation (leakage) features 14d can be compared to generate a frequency tracing graph, a spectrogram, and a category diagnostic result, and the position of the structural degradation (leakage) feature 14d in the under-test section 14s can be marked. The historical data are stored in the database 15.

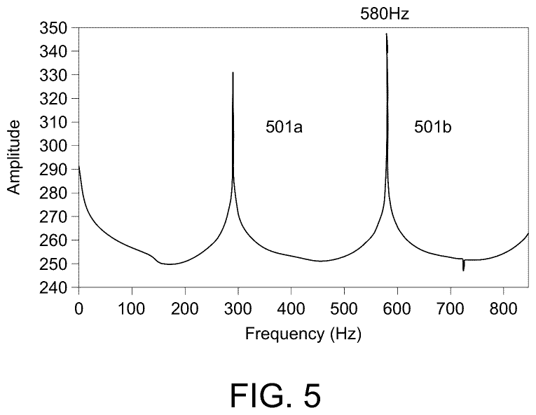

In details, when the under-test section 14s is determined to be in a leakage state, the frequency band of the under-test sound wave signal 14k having been processed with the time domain to frequency domain conversion will have at least one characteristic frequency (peak). FIG. 5 is a diagram illustrating a frequency band of an under-test acoustic signal 14k in a leakage state according to one embodiment of the present disclosure is shown. In the present embodiment, the under-test section 14s is determined as a metal tube in a leakage state according to the label value outputted from the feature label 12b of the diagnostic model 12m, and the frequency band of the under-test acoustic signal 14k has two characteristic frequencies 501a and 501b respectively at frequencies 290 Hz and 580 Hz.

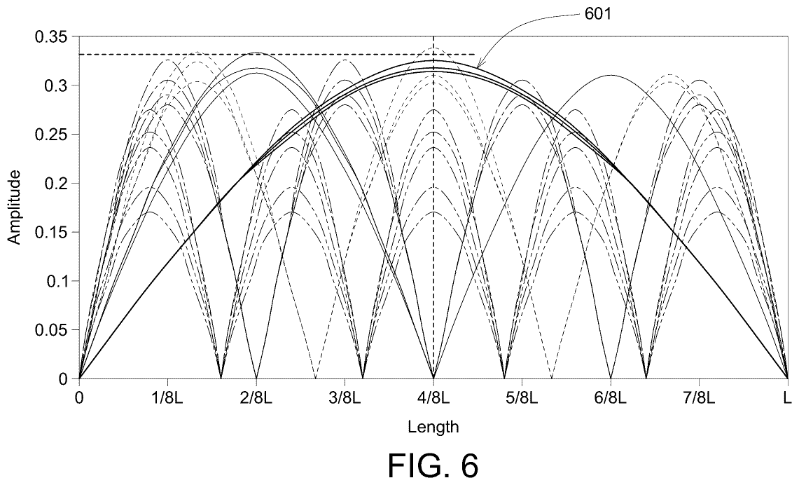

Then, the characteristic amplitude values of the characteristic frequencies 501a and 501b and their characteristic frequencies are compared with a plurality of amplitude vs position (length) curves of the under-test sections 14s with identical structural degradation (leakage) feature 14d but different feature positions obtained from different under-test sections 14s, that are stored in a database 15, to determine the position of the structural degradation (leakage) feature 14d in the under-test section 14s. FIG. 6 is a graph illustrating several amplitude (dB) vs position (length) curves of the under-test sections 14s with identical structural degradation feature (leakage) 14d in different feature positions, that are stored in the database 15, according to one embodiment of the present disclosure.

In the present embodiment, an amplitude (dBm) vs position (length, meter) curve 601 can be obtained from the database 15 according to the characteristic frequencies 501a and 501b. The amplitude vs position (length) curve 601 represents an amplitude vs position (length) curve corresponding to the frequency of 580 Hz. Then, since the crest position of the curve 601 converted according to the characteristic amplitude value 340 dB of the characteristic frequency 501b is close to the crest position at 4/8 L of the pipe length, relative position of the structural degradation feature (leakage) 14d can be marked as 4/8 L of the pipe length of the under-test section 14s.

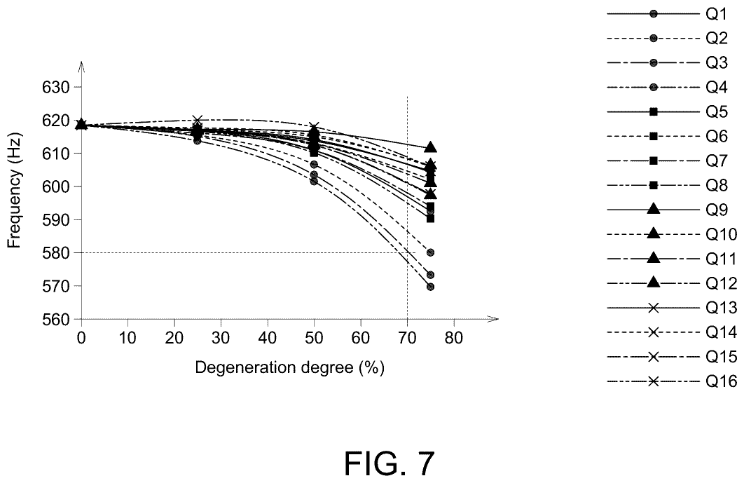

According to the characteristic amplitude values of the characteristic frequencies 501a and 501b, a plurality of amplitude vs degeneration curves 601 corresponding to specific characteristic frequencies in a database 15 can be compared to estimate the degeneration degree of the structural degradation feature (leakage) 14d. FIG. 7 is a graph illustrating several amplitude vs position (length) curves corresponding to specific characteristic frequencies, that are stored in the database 15, according to one embodiment of the present disclosure. The curves Q1 to Q16 respectively represent the amplitude vs degeneration relationship of different defect sizes. For example, for the intersection between the horizontal dotted line and the vertical dotted lines of FIG. 7, it can be estimated according to the sum of the characteristic frequency 302 (580 Hz) that the current structural degradation (leakage) feature 14d of the under-test section 14s has a degeneration degree of about 70%.

In some embodiments of the present disclosure, the structure detecting apparatus 100 further includes a Graphical User Interface (GUI) 17 constructed by an image processing circuit 100c (for example, including an embedded image processing card, an input/output circuit, an image processing chip, etc. (not shown)). Through the GUI 17, the results obtained by the acoustic resonance diagnostic module 12, the acoustic signals (e.g., the frequency tracking chart and frequency chart) collected by the acoustic sensing apparatus 11, the detection positions of the under-test structure 14 (pipeline structure) and the map indicating the leakage points can be directly displayed on the display screen of the user's computer in the form of a graph.

In addition, the communication interface 100a of the structure detecting apparatus 100 further includes a communication module 13. Through the communication module 13 (for example, a wireless network communication module), the contents displayed by the GUI 17 of the structure detecting apparatus 100 can be also displayed on the display interface of the handheld devices 131 (for example, a smartphones or notebooks, etc.) of the on-site leakage inspectors or other remote experts, thereby constructing a human-machine integrated interface; and allowing the on-site leakage inspectors or other remote experts to instantly obtain the results of the acoustic resonance diagnosis of the under-test structure, and sharing the detection information and historical records stored in a monitoring and management cloud platform.

In some embodiments of the present disclosure, the on-site leakage inspectors and the experts can provide comments or instructions for corrections to the acoustic resonance diagnostic module 12 through the handheld device 131 of the communication module 13 (according to their access authority) to modify and update the diagnostic model 12m of the acoustic resonance diagnostic module 12.

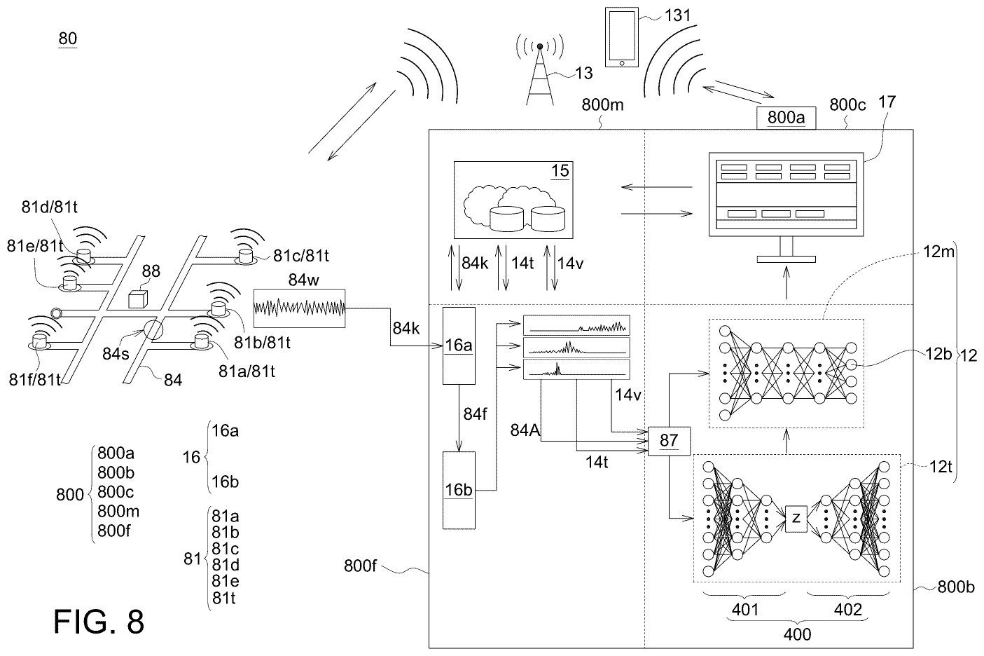

FIG. 8 is a block diagram illustrating another structure detecting kit 80 according to another embodiment of the present disclosure. The structure detecting kit 80 is similar to the structure detecting kit 10 as depicted in FIG. 1 except that the structure detecting kit 80 further includes an acoustic sensing apparatus 81 composed of a plurality of remote acoustic sensing units 81a-81e and a plurality of audio input/output interfaces 81t, which can be electrically connected to a communication interface 800a of the structure detecting apparatus 800 through the communication module 13 (for example, a wireless network communication module).

In some embodiments, the remote acoustic sensing units 81a-81e may be multiple remote leakage detecting probes respectively disposed on different under-test sections 84s of the under-test structure 84 (such as a pipeline structure), and are used to collect at least one under-test acoustic signal 84k. The structure detecting apparatus 800 further includes a Global Positioning System (GPS) (not shown) which can perform positioning for the under-test sections 84s where the remote acoustic sensing units 81a-81e are located. The audio input/output interface 81t of the acoustic sensing apparatus 81 can be used to input and output the at least one under-test acoustic signal 84k (including the signal that represents the waveforms of vibrating sound, hereinafter referred to as sound wave signal 84w) collected by the remote acoustic sensing units 81a-81e, thereby the under-test acoustic signal 84k can be transmitted to the structure detecting apparatus 800 (through communication module 13 and the communication interface 800a) for performing a subsequent structure detection; and the detection information results and historical records can be then stored in the database 15. In detail, the remote acoustic sensing units 81a-81e respectively include a remote leakage detecting probe, and the communication module 13 electrically connects the remote leakage detecting probe and the communication interface 800a of the structure detecting apparatus 800. Therefore, at least one under-test acoustic signal 84k collected by the acoustic sensing apparatus 81 can be transmitted to the structure detecting apparatus 800.

The logic circuit 800b of the structure detecting apparatus 800 further includes a data preprocessing module 87, which uses AI technology to filter out data that is invalid for structural detection from the under-test acoustic signal 84k, so as to reduce the computing load and improve the performance (such as diagnostic accuracy) of the acoustic resonance diagnostic module 12. For example, in the present embodiment, the data preprocessing module 87 applies machine learning, such as support vector machine (SVM) learning, to remove or replace data that is ineffective for detecting structural degradation from the under-test acoustic signal 84k (e.g. removing or replacing data from the three-dimensional vectors (the 5 (time)×2,000 (and amplitude) matrix as shown in FIG. 2) that are processed by the single-chip audio control circuit 16).

In detail, when the acoustic resonance diagnostic module 12 receives the under-test acoustic signal 84k, the single-chip audio control circuit 16 performs a time domain to frequency domain conversion (such as, a discrete square wave FFT and/or a MFC analysis) to convert the original time waveform of the under-test acoustic signal 84k into a three axes (amplitude, frequency and time) spectrogram 200, which is regarded as 2D/3D feature planes. That is, the single-chip audio control circuit 16 of the filter amplifier circuit 800f of the structure detecting apparatus 800 transforms and splits the under-test acoustic signal 84k into a filtered signal 14f. A portion of the frequency domain band of the filtered signal 14f is captured and amplified to serve as the filtered-and-amplified signal 84A for subsequent acoustic resonance diagnosis. After the environmental noise in the filtered-and-amplified signal 84A is removed by the data preprocessing module 87, the data is handed over to the logic circuit 800b to continue the subsequent structural detection (the subsequent acoustic resonance diagnosis).

The data of the above steps are stored in the memory unit 800m; and the diagnostic results obtained from the acoustic resonance diagnostic module 12, the acoustic signal collected by the acoustic sensing apparatus 81, the detection locations of the under-test structure (pipeline structure) 84 and the map indicating the leakage points, etc. can be directly displayed on the display screen of the structure detecting apparatus 800 in the form of a graph through the image processing circuit 800c.

As disclosed in above embodiments, the present disclosure provides a structure detecting apparatus and structure detecting kit applying the same using acoustic resonance diagnostic technology to determine the structural state of at least one under-test structure. Wherein, at least one communication interface, a filter amplifier circuit and a logic circuit are integrated into the structure detecting apparatus. The communication interface is used, in a contact or non-contact manner, to receive at least one under-test acoustic signal that is collected from the at least one under-test structure and outputted by a remote acoustic sensing unit or a proximal acoustic sensing unit. The received under-test acoustic signal is then filtered by the filter amplifier circuit and at least one filtered-and-amplified signal is outputted from the filter amplifier circuit. The state of the under-test structure can be determined by a diagnostic model configured with a CNN in the logic circuit based on the filtered-and-amplified signal output by the filter amplifier circuit. Thereby, remote sensing diagnosis and monitoring of the state of the under-test structure (for example, thinning and leakage of pipelines) can be realized to ensure the safe operation of the under-test structure (pipelines).

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A structure detecting apparatus, used for receiving at least one under-test acoustic signal of at least one under-test structure and determining a structural state of the under-test structure, comprising:
a communication interface, used to receive the at least one under-test acoustic signal;
a filter amplifier circuit, used to filter the at least one under-test acoustic signal and output at least one filtered-and-amplified signal; and
a logic circuit, comprising a diagnostic model configured with a convolutional neural network (CNN) and is used to determine the structural state of the at least one under-test structure based on the at least one filtered-and-amplified signal.

2. The structure detecting apparatus according to claim 1, wherein the filter amplifier circuit is used to perform a square wave Fast Fourier Transform (FFT) and perform a Mel-Frequency Cepstrum (MFC) analysis on the under-test acoustic signal.

3. The structure detecting apparatus according to claim 2, wherein the filter amplifier circuit comprises:
an audio transcoder, used to perform a time domain to frequency domain conversion to convert a time waveform of the at least one under-test acoustic signal into a frequency-domain waveform; and to capture a portion of the frequency-domain waveform serving as at least one filtered signal; and
a filter amplifier, used to capture and amplify the at least one filtered signal, and outputting a frequency domain band as the filtered-and-amplified signal.

4. The structure detecting apparatus according to claim 3, wherein the filter amplifier circuit is a single-chip audio control circuit.

5. The structure detecting apparatus according to claim 3, wherein the logic circuit comprises a Microcontroller Unit (MCU) provided for establishing the diagnostic model, by which the structural state of the under-test structure can be determined based on the frequency domain band.

6. The structure detecting apparatus according to claim 5, further comprising a memory unit used to store a plurality of feature values; wherein determining the structural state of the under-test structure comprises determining a degradation type of the under-test structure based on the plurality of feature values.

7. A structure detecting kit, used for receiving at least one under-test acoustic signal of at least one under-test structure and determining a structural state of the under-test structure, comprising:
an acoustic sensing apparatus, used to collect the at least one under-test acoustic signal; and
a structure detecting apparatus, comprising:
a communication interface, used to receive the at least one under-test acoustic signal;
a filter amplifier circuit, used to filter the at least one under-test acoustic signal and output at least one filtered-and-amplified signal; and
a logic circuit, comprising a diagnostic model configured with a CNN and is used to determine the structural state of the at least one under-test structure based on the at least one filtered-and-amplified signal.

8. The structure detecting kit according to claim 7, wherein the acoustic sensing apparatus comprises:
a remote acoustic sensing unit or a proximal acoustic sensing unit, used to collect the at least one under-test acoustic signal; and
an audio input/output interface, used to input and output the at least one under-test acoustic signal, and the at least one under-test acoustic signal is transmitted to the structure detecting apparatus through the communication interface.

9. The structure detecting kit according to claim 7, wherein the filter amplifier circuit is used to perform a square wave FFT and perform a MFC analysis on the under-test acoustic signal.

10. The structure detecting kit according to claim 9, wherein the filter amplifier circuit comprises:
an audio transcoder, used to perform a time domain to frequency domain conversion to convert a time waveform of the at least one under-test acoustic signal into a frequency-domain waveform; and to capture a portion of the frequency-domain waveform serving as at least one filtered signal; and
a filter amplifier, used to capture and amplify the at least one filtered signal, and outputting a frequency domain band as the filtered-and-amplified signal.

11. The structure detecting kit according to claim 10, wherein the filter amplifier circuit is a single-chip audio control circuit.

12. The structure detecting kit according to claim 10, wherein the logic circuit comprises a MCU provided for establishing the diagnostic model, by which the structural state of the under-test structure is determined based on the frequency domain band.

13. The structure detecting kit according to claim 12, further comprising a memory unit used to store a plurality of feature values; wherein determining the structural state of the under-test structure comprises determining a degradation type of the under-test structure based on the plurality of feature values.

14. The structure detecting kit according to claim 8, further comprising a communication module, wherein the remote acoustic sensing unit comprises a remote leakage detecting probe, and the communication module electrically connects the remote leakage detecting probe and the communication interface.

15. The structure detecting kit according to claim 8, wherein the proximal acoustic sensing unit comprises a handheld leak detection probe; and the communication interface comprises a signal line connecting the handheld leak detection probe and the filter amplifier circuit.
